(19) United States
(12) Patent Application Publication
(10) Pub. No.: US 2012/0182546 A1
(43) Pub. Date: Jul. 19, 2012

(54) METHOD AND DEVICE FOR SIMULTANEOUS MEASUREMENTS OF A SAMPLE IN A MULTIPHASE SYSTEM

(76) Inventors: Jamal Chaouki, Dorval (CA); Jean-Philippe Laviolette, Montreal (CA); Gregory Patience, Ville Mont-Royal (CA)

(21) Appl. No.: 13/498,934

(22) PCT Filed: Sep. 29, 2010
(86) PCT No.: PCT/CA2010/001550

§ 371 Date: Mar. 29, 2012

Related U.S. Application Data
(60) Provisional application No. 61/272,481, filed on Sep. 29, 2009.

(51) Int. Cl. G01N 21/59

(52) U.S. Cl. 356/73

(57) ABSTRACT

A method and a device for simultaneous and quantitative measurement of a carrier composition and a solids volume fraction in a gas/solid, liquid/solid, liquid/liquid, liquid/gas or gas/liquid/solid multiphase systems are presented. A first measurement identifies the phase of the sample and/or the solids fraction of the sample. A second measurement provides a liquid or gaseous chemical composition of the sample. The device comprises a generator of light that propagates through a sample of the multiphase system. A detector obtains a spectrum of absorbance of the light. The spectrum of absorbance is representative of measurements.

### TECHNICAL FIELD

The present disclosure relates to the field of multiphase system characterization. More specifically, the present disclosure relates to a method and a device for simultaneous measurements of a sample in a gas/solid, liquid/solid, liquid/liquid or gas/liquid/solid multiphase system.

### BACKGROUND

Multiphase processes are common to many industries, for example petrochemical industry, chemical industry, pharmaceutical industry, energy industry, food industry, pulp and paper industry, etc. Multiphase processes are also present throughout the process chain: energy generation (combustors), transformation (gasifiers, chemical reactors, mixers and dryers), purification/separation (cyclones and precipitators) and waste disposal (chimneys).

System characterization through quantitative measurement of gaseous species carrier composition and solids volume fraction is used in process control, optimization and trouble-shooting in industries and laboratories. Such system characterization is also used in the development of hydrodynamic (gas/liquid/solid) and kinetic models.

Several non-invasive and invasive techniques have been developed to measure solids volume fraction in two- and three-phase systems.

Invasive techniques may involve insertion of probes to measure a local capacitance, conductivity, fluorescence, forward-scattering or back-scattering of light in a medium. The solids volume fraction is derived from that measurement, which can be made in-situ and in real-time. In liquid/solid or gas/liquid/solid systems, the slurry phase can also be sampled with special probes to measure the liquid and solids volume fractions.

Non-invasive techniques include tomography, densitometry and analysis of ultrasonic wave distortions. Such non-invasive techniques produce time- or space-averaged maps of solids volume fraction in multiphase systems with varying resolution.

Species concentrations in a gas, liquid or solid phase can be analyzed continuously or intermittently using analytical instruments (chromatograph, spectrometer, etc.) and may require a process shutdown. Sampling may present several disadvantages: loss in production due to shutdown, system perturbation from probe insertion (measuring errors may range from 5% to 100%), sample destruction and loss of product.

During reaction, the solids volume fraction influences chemical reactions through heterogeneous catalytic and/or inhibitive effects as well as through thermal balance. Furthermore, from a hydrodynamic aspect, multiphase systems are often characterized by different regions of varying void fraction, and the species composition in these regions are not available for process characterization. For example, bubbling and turbulent gas/solid fluidized beds are characterized by a dense phase (emulsion) and a dilute phase (bubbles). Bubbles cause gas by-passing that lowers process yield such that inter-phase mass transfer is promoted through the reactor design. The simultaneous measurement of gaseous species carrier composition and solids volume fraction discriminates between the reactants in the dilute and dense phases, but such simultaneous measurement can hardly be made with existing methods.

An efficient measurement technique capable of yielding gaseous species carrier composition and solids volume fraction simultaneously would allow simultaneous measurement of both parameters requiring a single instrument compared to two instruments, potentially reducing measurement complexity and equipment costs. Such a measurement technique would give further insights into multiphase processes, as gaseous species concentrations and solids volume fraction may constitute dependent parameters, because of coupling through the reaction kinetics and hydrodynamics.

### SUMMARY

Therefore, there is a need for methods and devices for simultaneous measurement of a sample in a gas/solid, liquid/solid, liquid/liquid, liquid/gas or gas/liquid/solid multiphase system.

According to an aspect, there is provided a method for performing two simultaneous measurements of a sample in a gas/solid, liquid/solid, liquid/liquid gas/liquid or gas/liquid/solid multiphase system. The method comprises a first measurement of at least one of the following: a phase in which the sample lies, and/or a solids volume fraction of the sample. A second simultaneous measurement is performed of a gaseous or liquid chemical composition of the sample.

According to another aspect, there is also provided a device for performing two simultaneous measurements of a sample in a gas/solid liquid/solid, liquid/liquid, gas/liquid or gas/liquid/solid multiphase system. The device comprises a generator of light beam for propagating through the sample of the multiphase system. The device also comprises a detector of a spectrum of absorbance of the light beam propagating through the sample in response to said light beam having propagated through the sample. The spectrum of absorbance is representative of the two simultaneous measurements.

The foregoing and other features will become more apparent upon reading of the following non-restrictive description of examples of implementation thereof, given by way of illustration only with reference to the accompanying drawings.

### BRIEF DESCRIPTION OF THE DRAWINGS

Embodiments will be described by way of example only with reference to the accompanying drawings, in which:

FIG. 1 is a block diagram of a first embodiment of a spectroscopic device;

FIG. 2 is a block diagram of a second embodiment of the spectroscopic device;

FIG. 3 is a block diagram of a third embodiment of the spectroscopic device;

FIGS. 4a-4d are graphs showing (a) an absorbance spectrum of air, (b) an absorbance spectrum for air and a solids volume fraction, (c) an absorbance spectrum for air mixed with propane, and (d) an absorbance spectrum for air mixed with propane and a solids volume fraction;

FIGS. 5a-5b are graphs showing (a) typical interferograms measured with the spectroscopic device of FIG. 2, and (b) corresponding single-beam spectra;

FIGS. 6a-6b are graphs showing (a) an average absorbance of a methane peak as a function of methane molar fraction, and (b) an average baseline absorbance as a function of solids volume fraction;

FIG. 7 is a graph showing a history of baseline absorbance for three solid flows;

FIGS. 8a-8b are graphs showing (a) an average baseline absorbance and an average methane peak absorbance as a function of time, and (b) a measured methane molar fraction and solids volume fraction as a function of time;

FIG. 9 is a graph showing a measured gaseous species carrier composition as a function of time and a representation of relative deviations from a real value;

FIGS. 10a-10b are graphs (a) obtained by taking a background spectrum of a mixture of methane in nitrogen and measuring an absorbance spectra of air with two time-averaged solids volume fraction, and (b) showing a spectrum of a single IR beam and a spectrum of fiber-optics for air and solids volume fraction;

FIG. 11 is a graph showing a variance as a function of time-average methane molar fraction and solids volume fraction;

FIG. 12 is a graph showing a history of solids volume fraction and methane molar fraction measured by the spectrometer of FIG. 3;

FIGS. 13a-13c are graphs showing (a) a typical absorbance spectrum measured in an emulsion phase, (b) an absorbance spectrum measured inside a bubble phase, and (c) a typical absorbance spectrum where noise is observed; and

FIGS. 14a-14f are schematic views of various multiphase reactors.

### DETAILED DESCRIPTION

Multiphase systems are generally characterized by compositions of gas, liquids and/or solids, which are heterogeneous in space and time. As an example of a multiphase system, a substance, for example a solids volume fraction, may be dispersed throughout a carrier, for example a gas. Another multiphase system may comprise a first liquid fraction blended in a second liquid forming a carrier, wherein the two liquids are immiscible, droplets of the first liquid forming small particles dispersed within the second liquid carrier. Yet another multiphase system may comprise a fluid carrier in which a fraction consisting of a gas/liquid bubble, a solid/gas emulsion or a solid/liquid emulsion is blended. Considering as an example the specific case of gas/solid systems, in-situ and real-time measurement of gaseous species concentrations in different regions of a multiphase system requires a simultaneous determination of solids volume fraction. A measurement volume can be made independent of the solid properties by inclining emitting and receiving fiber-optics to form a convergent scheme. This principle can be applied to an IR fiber-optic probe to measure gaseous species concentrations.

As used herein, the term “phase” is understood as a physically distinct, separable portion of matter present in a non-homogeneous physicochemical system. A phase may be solid, liquid or gaseous. A phase may consist of a mixture of distinguishable components: an emulsion is considered a “dense” fractional phase while bubbles of a component in a carrier form a “dilute” fractional phase. A phase may also be slurry, for example a watery mixture such as mud.

In multiphase systems, movement of solid powders, liquid droplets, or like particles, makes spectroscopy measurements and interpretation more complex. In an exemplary multiphase system comprising a solids volume fraction mixed within a gaseous carrier, measured absorbance spectra are influenced by variations in the solids volume fraction and an average distance from a sample to a probe. When samples are moving, different parts of the spectrum may also be influenced to a varying degree by local heterogeneities, due for example to different material components. The effect of moving particles on Fourier-Transform spectroscopy is to produce artifacts on the measured spectrum at certain wavenumbers, or wavelengths, that are dependent upon a timescale of the spectral scan compared to the rate of movement of the particles. The wavenumbers at which the artifacts appear increase with increasing modulation frequencies, corresponding to a number of displacements per second of a moving mirror in an interferometer, one displacement being equal to a laser wavelength. Consequently, the effects of moving particles may be completely eliminated at the wavenumbers of interest with a sufficiently high modulation frequency. This discovery applies in various types of multiphase systems, for example whether the carrier is liquid or gaseous or whether the fraction is a liquid or a solid, in various combinations.

Infrared (IR) spectroscopy offers a great potential for simultaneous measurement of carrier compositions and volume fractions. IR spectroscopic applications in multiphase systems are affected by particle phase characteristics. More specifically, the volume fraction and particle size influence the interaction between light and the particles, which in turn may affect a length of the trajectory of an IR beam and effective sample size. For example, an increase in particle size may decrease the fraction of scattered light and may thus increase penetration depth of light into the particles, resulting in increased absorbance and an upward shift of the absorbance baseline in diffuse reflectance spectroscopy.

Non-limitative examples of implementation of a spectroscopic device and method disclosed herein, for a simultaneous and quantitative measurement of multiphase systems, will now be described. Experimental results will be presented for specific, however non-limiting cases involving gaseous species carrier compositions Yᵢ and solids volume fractions (1-ε).

### Example 1

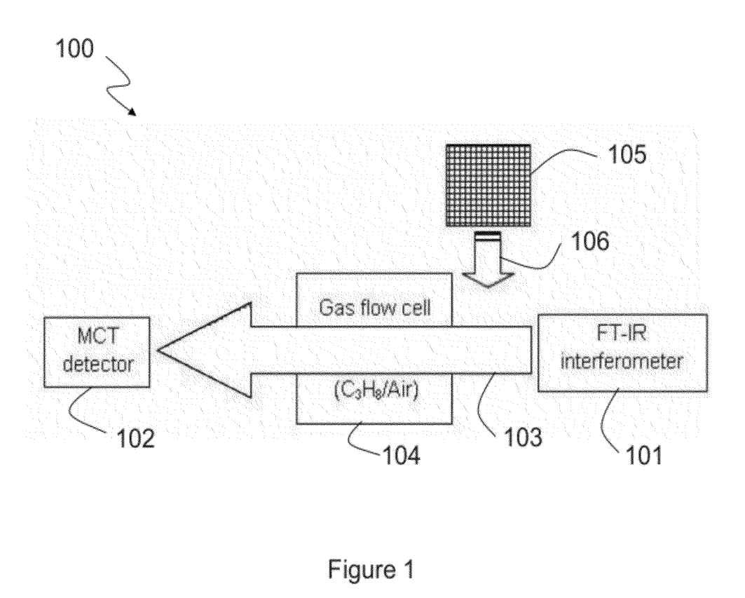

FIG. 1 is a block diagram of a first embodiment of a spectroscopic device. A spectroscopic device 100, used for tests involving simultaneous and quantitative measurement of gaseous carrier species composition Yᵢ and solids volume fraction (1-ε), comprises a Fourier Transformed-InfraRed (FT-IR) spectrometer, for example a Varian Excalibur™ series 3100, including a FT-IR interferometer 101 and a high sensitivity mercury-cadmium-telluride (MCT) detector 102 cooled with liquid nitrogen. The FT-IR interferometer 101, also called a generator, produces an light beam, such as for example an infrared light (IR) beam 103, propagating through a gas flow cell 104 placed in a sample compartment of the FT-IR spectrometer, and the MCT detector 102 measures the spectrum of absorbance of the IR light beam 103. The gas flow cell 104 may be substituted with a liquid flow cell (not shown), for example for evaluation of a solid/liquid system. A metal mesh 105 can be placed between the FT-IR interferometer 101 and the gas flow cell 104, insertion of the metal mesh 105 in the trajectory of the IR light beam 103 being identified by arrow 106.

Using the exemplary spectroscopic device 100, a first series of tests were conducted using near- and mid-IR Fourier transform transmission spectroscopy, at wavelengths in a range of 6000-1000 cm⁻¹.

More specifically, in the first series of tests, the IR light beam 103 from the FT-IR interferometer 101 was transmitted through the gas flow cell 104 and the spectrum of absorbance of the IR light beam 103 was measured by the MCT detector 102. Prior to each experiment, the spectroscopic device 100 was used to measure a background spectrum of absorbance of the IR light beam 103 in air by flushing the gas flow cell 104 with air and by co-adding twenty (20) measured spectra. Then, a gas/solid system was simulated in the sample compartment of the FT-IR spectrometer by injecting a carrier containing 1.8 vol % propane (C₃H₈) in air inside the gas flow cell 104 and by placing the metal mesh 105 in the trajectory of the IR light beam 103. The metal mesh 105 had an open area ratio of 16%, corresponding to a solids volume fraction (1-ε) equal to 0.84, and a thickness of 1 mm.

Results and Discussion

During transmission spectroscopy in a gas/solid sample, both solid particles and gaseous species contribute to the absorbance spectrum according to Equation (1), mathematically represented further and described as follows: The total absorbance A_{Total, λ} at wavelength λ has a contribution A_{(1-ε),λ} from the solids volume fraction (1-ε) and a contribution A_{Yi,λ} from the gaseous species carrier composition Yᵢ. Solid particles reduce the incident beam intensity by absorption, reflection and diffusion. Solids can also influence the length of the trajectory of the IR light beam 103 and the volume of the sample such that the absorbance due to the chemical species is a function fn of solids volume fraction (1-ε).

A_{Total,λ}=A_{(1-ε),λ}+A_{Y}_{ᵢ}_{,λ}[fn(1-ε)] (1)

In the specific case of transmission spectroscopy, where the effect of solids volume fraction (1-ε) on the length of the trajectory and the volume of the sample can be neglected, Equation (1) can be simplified to Equation (2): (2)

A_{Total,λ}=A_{(1-ε),λ}+A_{Y}_{ᵢ}_{,λ} (2)

In Equation (2), the effects of solids volume fraction (1-ε) and gaseous carrier species composition Yᵢ on the absorbance spectrum are independent. Therefore, the effects of solids volume fraction (1-ε) and gaseous species carrier composition Yᵢ can be calibrated independently.

Tests with the Spectroscopic Device 100

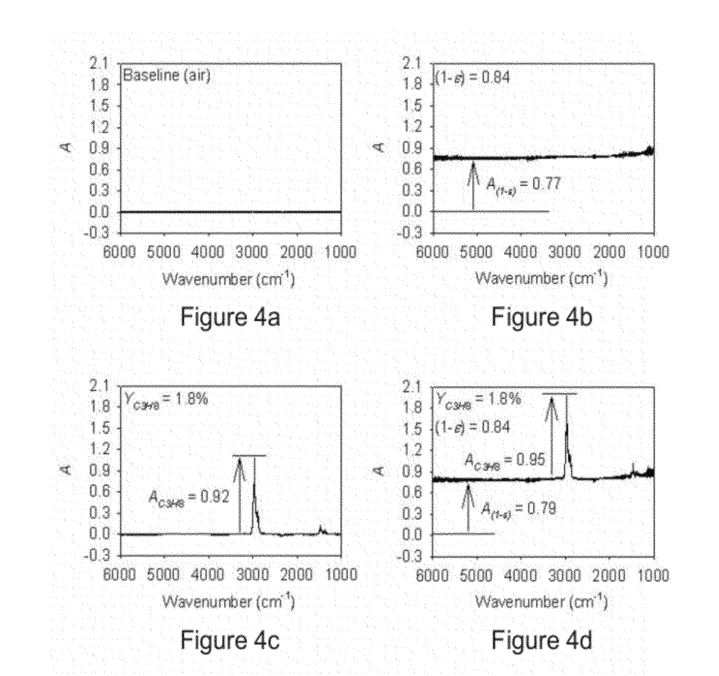

As indicated hereinabove, the first series of test were conducted using the spectroscopic device 100 of FIG. 1 and were directed to a solid/gas system. The above described background spectrum of absorbance of the IR light beam 103 in air was measured using the spectroscopic device 100 and four (4) absorbance spectra were subsequently measured by the MCT detector 102 for four (4) corresponding conditions (4 samples). Results of the first series of test are illustrated in FIGS. 4a-4d, which are graphs showing (a) an absorbance spectrum of air, (b) an absorbance spectrum for air and a solids volume fraction, (c) an absorbance spectrum for air mixed with propane, and (d) an absorbance spectrum for air mixed with propane and a solids volume fraction, as follows:
Air carrier and solids volume fraction (1-ε)=0 (FIG. 4a);
Air carrier and solids volume fraction (1-ε)=0.84 (FIG. 4b);
1.8% C₃H₈+98.2% air carrier and solids volume fraction (1-ε)=0 (FIG. 4c); and
1.8% C₃H₈+98.2% air carrier and solids volume fraction (1-ε)=0.84 (FIG. 4d).

FIG. 4a shows the spectrum of absorbance of the IR light beam 103 in air, which corresponds to the background absorbance spectrum and resulted in a baseline of zero absorbance.

Two calibration absorbance spectra (FIGS. 4b and 4c) were measured to independently evaluate the effect of the propane (C₃H₈) molar fraction and the solids volume fraction (1-ε).

FIG. 4b shows the spectrum of absorbance of the IR light beam 103 in air and a solids volume fraction (1-ε) equal to 0.84, wherein the solids volume fraction was obtained by placing the metal mesh 105 in the trajectory of the IR light beam 103. As shown in FIG. 4b, the baseline absorbance increased almost uniformly across the spectrum from zero (0) to a higher absorbance. The average baseline absorbance was 0.77 through the wavelength region of 3436.90-3427.98 cm⁻¹.

A second calibration absorbance spectrum was measured by injecting a carrier, composed of 1.8% of propane (C₃H₈) mixed with air, inside the gas flow cell 104, and by removing the metal mesh 105 from the sample compartment of the FT-IR spectrometer. FIG. 4c shows the spectrum of absorbance of the IR light beam 103 in 1.8% C₃H₈+98.2% air and solids volume fraction (1-ε) equal to zero (0). As shown by FIG. 4c, the injection of propane (C₃H₈) resulted in the formation of two absorbance peaks at wavelengths of 2967.96 and 1471.68 cm⁻¹. The average peak height of the tallest peak, at 2967.96 cm⁻¹, was 0.92 in the region of 2969.65-2966.27 cm⁻¹.

Finally, the propane (C₃H₈) concentration and the solids volume fraction (1-ε) were measured simultaneously. More specifically, the mixture of 1.8% of propane (C₃H₈) in air was injected inside the gas flow cell 104 and the metal mesh 105 was inserted inside the sample compartment (see arrow 106) in the trajectory of the IR light beam 103. FIG. 4d shows the spectrum of absorbance of the IR light beam 103 in the 1.8% C₃H₈+98.2% air carrier, with the solids volume fraction (1-ε) equal to 0.84. As illustrated in FIG. 4d, the baseline absorbance was 0.79 (compared to 0.77 in FIG. 4b) and the average propane (C₃H₈) peak height above the baseline was 0.95 (compared to 0.92 in FIG. 4c). Therefore, the concentration of the propane (C₃H₈) and the solids volume fraction (1-ε) were measured simultaneously using the spectroscopic device 100 of FIG. 1 with a relative error of approximately 3% if a linear relation between absorbance and the two parameters is assumed. Equation (2) was thus valid in that particular case, since the metal mesh 105 had no appreciable influence on the length of the trajectory of the IR beam 103—the length of the trajectory of the IR beam 103 was defined by the width of the sample compartment.

### Example 2

In this Example 2, in-situ and real-time measurements were conducted in a gas/solid flow of a methane (CH₄)/nitrogen (N₂) carrier and silica sand particles fraction, the silica sand particles having an average particle size (dp) of 290 μm. Absorbance spectra were recorded at a frequency of 4.5 Hz for a period of 75 seconds and both gaseous species carrier composition Yᵢ and solids volume fraction (1-ε) were evaluated from each spectrum. Methane (CH₄) molar fractions in nitrogen (N₂) were measured over a range of 0-10.1 volume %. Furthermore, the solids volume fraction (1-ε) was varied between 0-0.1.

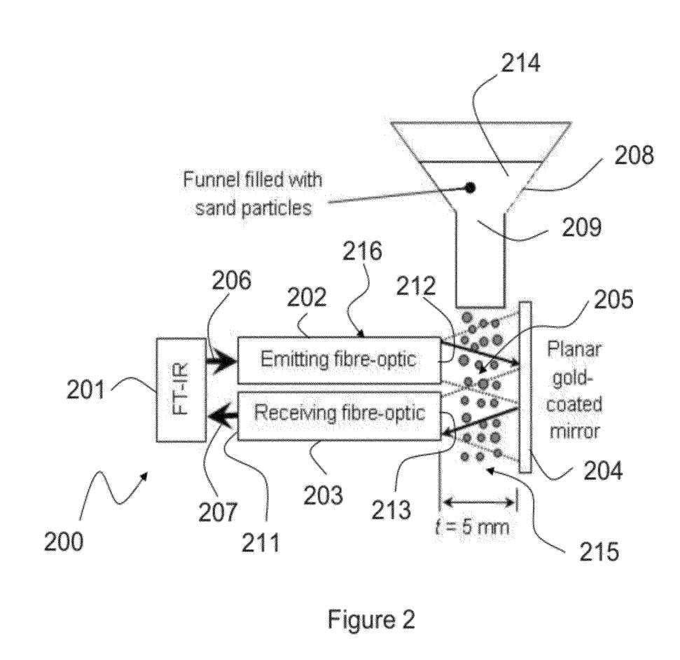

FIG. 2 is a block diagram of a second embodiment of the spectroscopic device. A spectroscopic device 200 was used in Example 2 for performing two simultaneous measurements of gaseous species carrier composition Yᵢ and solids volume fraction (1-ε). This Example 2 and results presented hereinbelow do not limit the scope of the present disclosure since the spectroscopic device 200 may also be used for performing measurements of other types of multiphase systems comprising for example liquid/solid, liquid/liquid, gas/liquid or gas/liquid/solid multiphase systems. The spectroscopic device 200 comprises:
a FT-IR spectrometer 201, for example Varian Excalibur™ series 3100, equipped with a FT-IR interferometer (not shown) and a high sensitivity mercury-cadmium-telluride (MCT) detector (not shown) cooled with liquid nitrogen;
a fiber-optic probe 216 comprising:
   an emitting fiber-optic 202 made of fluoride glass, having a numerical aperture of 0.2 and a core diameter of 600 μm, and having a proximal end 210 optically coupled to the FT-IR interferometer of the spectrometer 201 through an appropriate optical coupler (not shown), for example a Harrick Fibremate™; and
   a receiving fiber-optic 203 parallel to the emitting fiber-optic 202, made of fluoride glass, having a numerical aperture of 0.2 and a core diameter of 600 μm, and having a proximal end 211 optically coupled to the MCT detector of the spectrometer 201 through the above-mentioned optical coupler (not shown), for example a Harrick Fibremate™ and
a planar gold-coated mirror 204 positioned perpendicular to distal tips 212 and 213 of the emitting fiber-optic 202 and receiving fiber-optic 203, at a distance d=5 mm from these distal tips 212 and 213, defining a gas/solid flow measurement volume 205.

Although the spectroscopic device 200 is described with specific components, it should be understood by those skilled in the art that any component could be replaced by similar components capable of performing similar functions. For example, the planar gold-coated mirror 204 could be replaced by any other type of mirror capable of maximizing the reflection of the incident light beam. Furthermore, the mirror could be located with respect to the a mirror at a given distance from the fiber-optic probe and oriented so as to maximize transmission of the light beam to the detector.

A second series of tests were performed using the spectroscopic device 200 of FIG. 2. More specifically, in-situ and real-time measurements of gaseous species carrier composition Yᵢ and solids volume fraction (1-ε) were conducted inside a gas/solid flow of methane (CH₄)/nitrogen (N₂) mixtures and silica sand particles (dp) of 290 μm.

In operation, the FT-IR interferometer of the spectrometer 201 produced an IR light beam 206 propagated through the emitting fiber optic 202 and then through the measurement volume 205. The planar gold-coated mirror 204 positioned perpendicularly at a distance of 5 mm from the distal tip of the fiber-optic probe 216 reflected the IR light beam 206 from the distal tip 212 of the emitting fiber-optic 202 toward the distal tip 213 of the receiving fiber-optic 203 to define the measurement volume generally shown at 205. The receiving fiber-optic 203 propagated the reflected IR light beam 207 toward the MCT detector of the FT-IR spectrometer 201. A funnel 208 filled with the silica sand 214 was mounted above the measurement volume 205 to produce a flow 215 of solid particles through that measurement volume. The flow 215 of solid particles could be varied by changing the diameter of the funnel 208 at its throat 209.

The second series of tests were conducted by first measuring a background spectrum of absorbance of the IR light beam in a methane (CH₄)/nitrogen (N₂) mixture injected inside the measurement volume 205 using a calibrated gas cylinder (not shown). The background spectrum was obtained from the co-addition of 20 measured spectra.

Then, the funnel 208 was filled with silica sand particles 214 to initiate the flow 215 of solids. Four solids volume fraction (1-ε) were used: 0, 0.015, 0.038 and 0.097; the flow 215 of silica sand particles 214 was varied by changing the diameter of the funnel 208 at its throat 209. Also, four different methane (CH₄)/nitrogen (N₂) compositions were injected from calibrated gas cylinders in the measurement volume 205: 0, 0.1, 3.25 and 10.1 vol % of methane (CH₄) in nitrogen (N₂). Spectra of absorbance of the IR light beam were measured at a frequency of 4.5 Hz, yielding a temporal resolution of 0.22 second, and a methane molar fraction Y_{CH4} was measured simultaneously with the solids volume fraction (1-ε).

Results and Discussion

As described in the foregoing description, during transmission spectroscopy in a multiphase system such as the exemplary gas/solid sample used for the tests of Example 2, both particles and carrier species contribute to the absorbance spectrum according to Equation (1), which may be simplified to Equation (2). As expressed hereinabove, in Equation (2), the effects of the solids volume fraction (1-ε) and gaseous species carrier composition Yᵢ on the absorbance spectrum are independent. Therefore, the effect of solids volume fraction (1-ε) and gaseous species carrier composition Yᵢ may be calibrated independently.

Tests with the Spectroscopic Device 200

Effect of Particle Movement

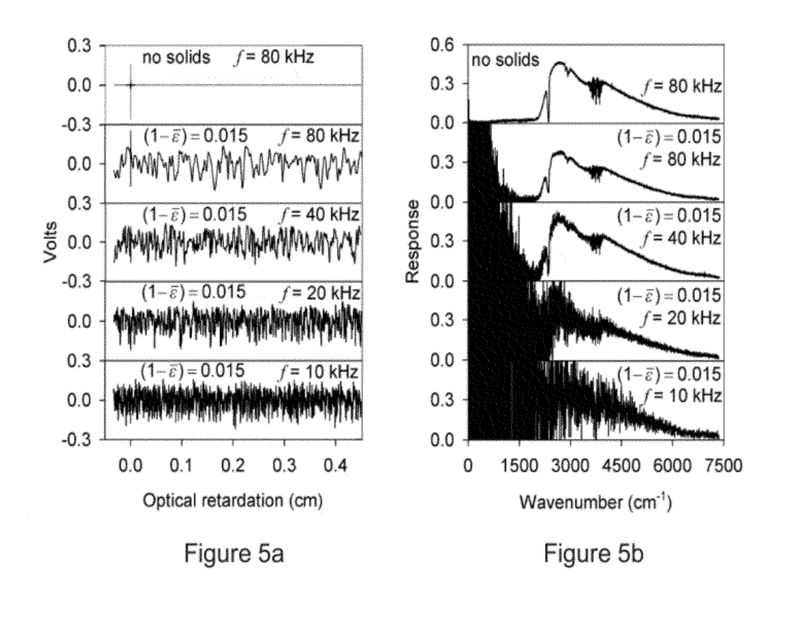

FIGS. 5a-5b are graphs showing (a) typical interferograms measured with the exemplary embodiment of the spectroscopic device as shown on FIG. 2, and (b) corresponding single-beam spectra. These graphs illustrate measurements in air at different modulation frequencies and two solids volume fractions. A modulation frequency represents a number of displacements of 632.8 nm, corresponding to the laser wavelength, that the moving mirror makes per second in the FT-IR interferometer of the spectrometer 201. FIG. 5a shows typical interferograms measured with the spectroscopic device 200 of FIG. 2 in air, at different modulation frequencies, and two solids volume fractions (1-ε). In the absence of solids particles, the interferogram is characterized by a centreburst at an optical retardation of zero (0) cm and a signal decay at higher optical retardation. With a flow of solids in the measurement volume 205 that corresponds to a time-average solids volume fraction (1-ε) of 0.015, fluctuations in the signal appear. The number of fluctuations decreases as the modulation frequency (f) is increased from 10 to 80 kHz. FIG. 5b shows corresponding single-beam spectra. In the absence of solid particles, the spectrum is characterized by a reasonably high signal-to-noise ratio (S/N) over the entire spectrum. However, with a flow 215 of silica sand particles 214 at a solids volume fraction (1-ε) equal to 0.015, noise is observed in the regions of low wavenumber, that is, at high wavelengths and low frequencies. The noise is produced by temporal variations in the intensity of the propagated IR light beam 206 due to heterogeneities in the gas/solid flow. As the modulation frequency increases from 10 to 80 kHz, the noise moves to lower wavenumbers. As the mirror speed increases, a growing number of wavenumbers are modulated to frequencies that are significantly higher than the frequency at which the moving silica particles 215 change the intensity of the transmitted IR beam 206. At high wavenumbers, the signal amplitude remains largely unaffected by the movement of the silica sand particles 214. At a modulation frequency of 80 kHz, the artifacts are outside a wavenumber range of interest defined as 2700-3300 cm⁻¹ and the second series of tests was therefore performed with this setting. Tests were also performed at higher solids volume fractions (1-ε) with no significant effect on the location of the fluctuations observed in the spectra.

The spectroscopic device 200 was also used to measure in-situ absorbance spectra across the flow 215 of silica sand particles 214. As described in the foregoing description with reference to Example 1, IR spectroscopy is based on the ratio of the background and the measured spectra. It is simpler to measure a background spectrum of absorbance of the IR light beam in a mixture of methane (CH₄)/nitrogen (N₂), without solid particles, and conduct measurements with a flow 215 of silica sand particles 214 in air such that negative methane (CH₄) absorbance peaks are obtained. However, the methane molar fractions are reported as positive values in the present disclosure. The results are unaffected by this procedure since the length of the trajectory of the IR light beam and the measurement volume 205 are independent of the solids volume fraction (1-ε). When the planar gold-coated mirror 204 was removed, the amplitude of the signal measured by the MCT detector of the FT-IR spectrometer 201 was zero (0). This shows that the IR beam 207 collected by the receiving fiber-optic 203 had no contribution from diffuse reflectance on the solids surface and that the measurement volume 205 was only defined by the position of the planar gold-coated mirror 204. Furthermore, the effects of gaseous species carrier composition Yᵢ (methane concentration) and solids volume fraction (1-ε) on the spectrum of absorbance of the IR light beam were independent.

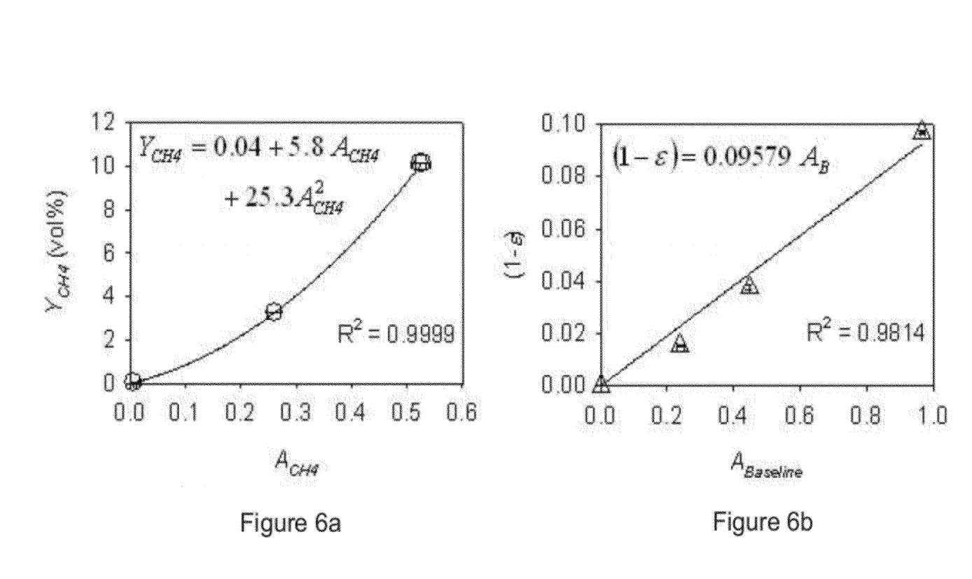

A calibration was first performed with the spectroscopic device 200 to evaluate the effect of gaseous species carrier composition Yᵢ (molar fraction of a gas i) and solids volume fraction (1-ε) on the absorbance spectrum. The effect of gaseous species carrier composition Yᵢ in this case a methane molar fraction Y_{CH4}, was calibrated with four (4) mixtures containing 0, 0.1, 3.25 and 10.1 vol % of methane (CH₄) in nitrogen (N₂). The average absorbance of the methane peak (A_{CH4}) was measured in the range of wavelengths 3018.96-3016.86 cm⁻¹. FIGS. 6a-6b are graphs showing (a) an average absorbance of a methane peak as a function of methane molar fraction, and (b) an average baseline absorbance as a function of solids volume fraction. FIG. 6a shows the average absorbance of the methane peak A_{CH4} measured in the region of wavelengths 3018.96-3016.86 cm⁻¹ as a function of methane molar fraction Y_{CH4}. As illustrated in FIG. 6a, the relationship between absorbance and the methane molar fraction Y_{CH4} was non-linear.

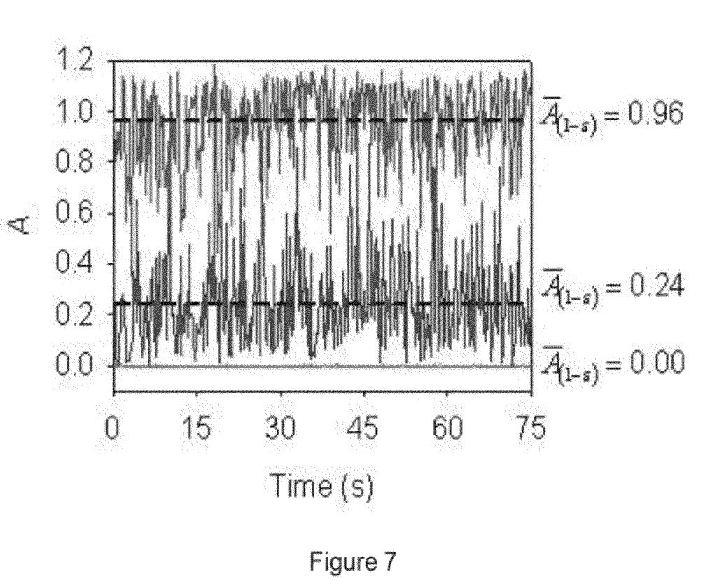

The effect of solids volume fraction (1-ε) was calibrated by varying the flow 215 of silica sand particles 214 in the measurement volume 205. Four solids volume fractions were used (0, 0.015, 0.038 and 0.097) and the average baseline absorbance (A_{(1-ε)}) was measured by the spectroscopic device 200 in the ranges of wavelengths 2997.73-2992.04, 3036.70-3030.72 and 3045.87-3040.39 cm⁻¹ during 75 seconds at a frequency of 4.5 Hz. FIG. 7 is a graph showing a history of baseline absorbance for three solid flows. The flows 215 shown on FIG. 2 correspond to time-averaged solids volume fraction (1-ε) of 0, 0.015 and 0.097. The measured absorbance fluctuates due to heterogeneities in the flow 215 of silica sand particles 214. FIG. 6b shows the average baseline absorbance as a function of solids volume fraction (1-ε). It may be observed that the relationship is close to linear.

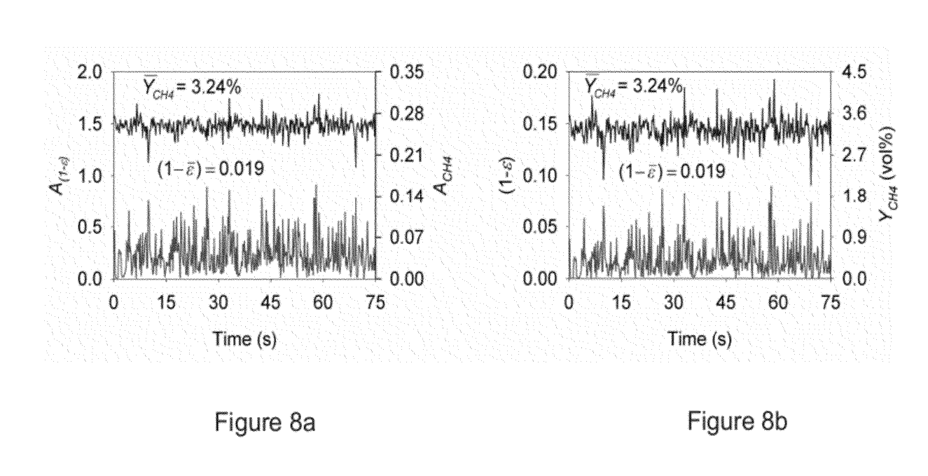

Finally, the spectroscopic device 200 was used to simultaneously measure the gaseous species carrier composition Yᵢ (methane molar fraction Y_{CH4}) and the solids volume fraction (1-ε). The procedure was the following: A background spectrum was first obtained with a mixture containing 3.25 vol % of methane (CH₄) in nitrogen (N₂). Then, a flow 215 of silica sand particles corresponding to a time-averaged solids volume fraction (1-ε) of 0.015 was initiated in air. Absorbance spectra were measured in real-time for 75 seconds, at a frequency of 4.5 Hz corresponding to a temporal resolution of 0.22 second. FIGS. 8a-8b are graphs showing (a) an average baseline absorbance and an average methane peak absorbance as a function of time, and (b) a measured methane molar fraction and solids volume fraction as a function of time. In FIG. 8a, the average baseline absorbance A_{(1-ε)} and the average methane peak absorbance A_{CH4} are shown as a function of time. Both absorbencies A_{CH4} and A_{(1-ε) fluctuate with time around time-averaged values of} 0.26 and 0.19, respectively. The calibrations of FIGS. 6(a) and 6(b) were used to calculate the instantaneous gaseous species carrier composition Yᵢ (methane molar fraction Y_{CH4}) and solids volume fraction (1-ε) during each time interval. FIG. 8b shows the measured methane molar fraction Y_{CH4} and solids volume fraction (1-ε) as a function of time. Both measurements fluctuate, but the time-averaged values are very close to the real values: A measurement of 3.24 vol % was obtained compared to an actual value of 3.25 vol % for the methane molar fraction Y_{CH4}, and a measurement of 0.019 was obtained compared to an actual value of 0.015 for the solids volume fraction (1-ε).

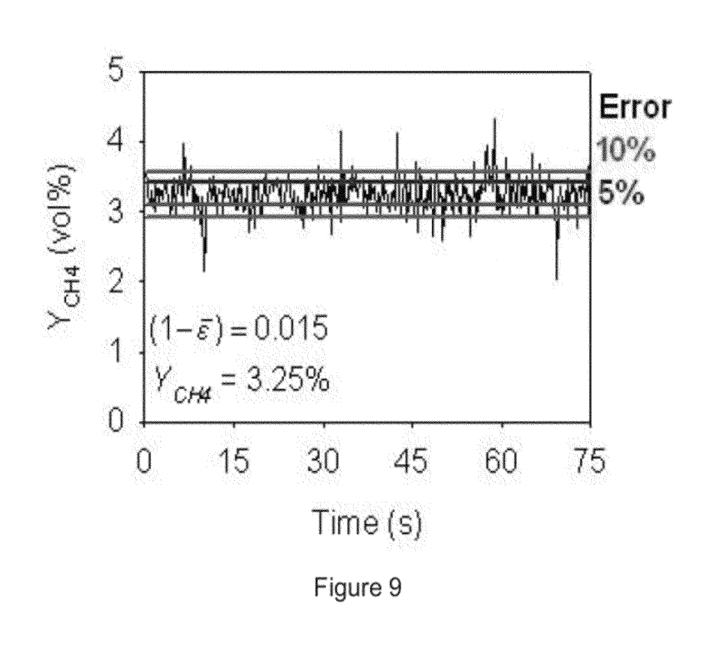

FIG. 9 is a graph showing a measured gaseous species carrier composition as a function of time and a representation of relative deviations from a real value. In FIG. 9, the measured gaseous species carrier composition Y, (methane molar fraction Y_{CH4}) is presented as a function of time and four (4) horizontal lines represent the +/−5% and +/−10% relative deviations from an actual value of 3.25 vol % of methane (CH₄). A majority of data points, 55%, were within 5% of the real value while 87% of data points had a relative error of 10% or less.

Table 1 lists tests in which the gaseous species carrier composition Yᵢ (methane molar fraction Y_{CH4}) and the solids volume fraction (1-ε) were measured simultaneously. The methane molar fraction Y_{CH4} and the solids volume fraction (1-ε) fed to the spectroscopic device 200 are listed for each test run along with measured time-averaged values obtained from the absorbance spectra. The measured time-averaged methane molar fraction Y_{CH4} and solids volume fraction (1-ε) were all very close to the real values: The maximum relative error on the measured methane molar fraction Y_{CH4} was 5.8%, this value being obtained in Run #9. Table 1 also shows the percentage of data points that had a relative error in the measured methane molar fraction Y_{CH4} of 5% and 10% or less—this percentage decreased with increasing solids volume fraction (1-ε). Increasing the solids volume fraction (1-ε) decreased the accuracy of the real-time and time-averaged methane molar fraction Y_{CH4} measurements.

TABLE 1

| | | | Measurements | | | |
|---|---|---|---|---|---|---|
| | | | | | Percentage (%) of Y_{CH4} | |
| | Fed to system | | | | measurements within a | |
| | Y_{CH4} | | Y̅_̅{̅C̅H̅4̅}̅ | | relative error of | |
| Run | (%) | (1 − ε) | (%) | (̅1̅ −̅ ε̅)̅ | +/−5% | +/−10% |
| 1 | 3.25 | 0.015 | 3.31 | 0.019 | 54 | 83 |
| 2 | 3.25 | 0.015 | 3.24 | 0.019 | 55 | 87 |
| 3 | 10.1 | 0.015 | 10.09 | 0.020 | 83 | 98 |
| 4 | 10.1 | 0.015 | 10.20 | 0.018 | 82 | 98 |
| 5 | 3.25 | 0.038 | 3.31 | 0.039 | 38 | 70 |
| 6 | 3.25 | 0.038 | 3.41 | 0.037 | 37 | 63 |
| 7 | 10.1 | 0.038 | 10.05 | 0.041 | 61 | 86 |
| 8 | 10.1 | 0.038 | 9.95 | 0.040 | 63 | 87 |
| 9 | 3.25 | 0.097 | 3.44 | 0.097 | 18 | 31 |
| 10 | 10.1 | 0.097 | 10.06 | 0.098 | 30 | 55 |

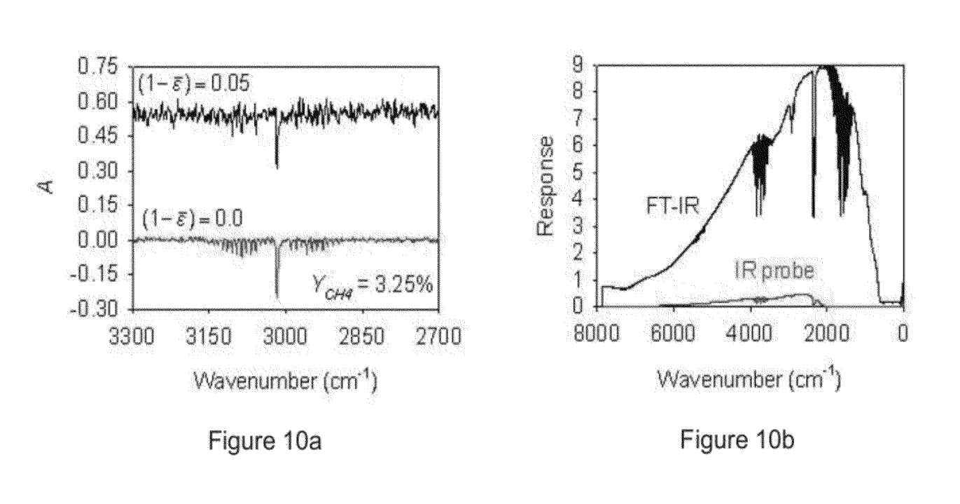

It can be appreciated that as the solids volume fraction (1-ε) increased, the intensity of the transmitted IR beam 206 decreased and the signal-to-noise ratio (S/N) of the FT-IR measurements decreased accordingly. FIGS. 10a-10b are graphs (a) obtained by taking a background spectrum of a mixture of methane in nitrogen and measuring an absorbance spectra of air with two time-averaged solids volume fraction, and (b) showing a spectrum of a single IR beam and a spectrum of fiber-optics for air and solids volume fraction. FIG. 10a was obtained by taking a background spectrum of a mixture of 3.25 vol % of methane (CH₄) in nitrogen (N₂) and measuring the absorbance spectra of air with two time-averaged solids volume fraction (1-ε): 0 and 0.015. FIG. 10a shows that a time-averaged solids volume fraction (1-ε) of 0.015 results in a significantly lower S/N and the fluctuations of the baseline were of the same order as the methane peak, located at the wavelength of 3017.63 cm⁻¹.

The intensity of the IR beam is a concern with the fiber-optics 202 and 203 of FIG. 2 since their use significantly reduces the amplitude of the effective IR signal. FIG. 10b shows the spectrum of the single IR beam and the spectrum of the fiber-optic probe 216 for air and solids volume fraction (1-ε) set to zero (0). The IR signal intensity reduced by a factor of approximately 288 when the fiber-optic probe 216 including the fiber-optics 202 and 203 was installed. To compensate, the sensitivity of the MCT detector of the spectroscopic device 200 was increased by a factor of 16.

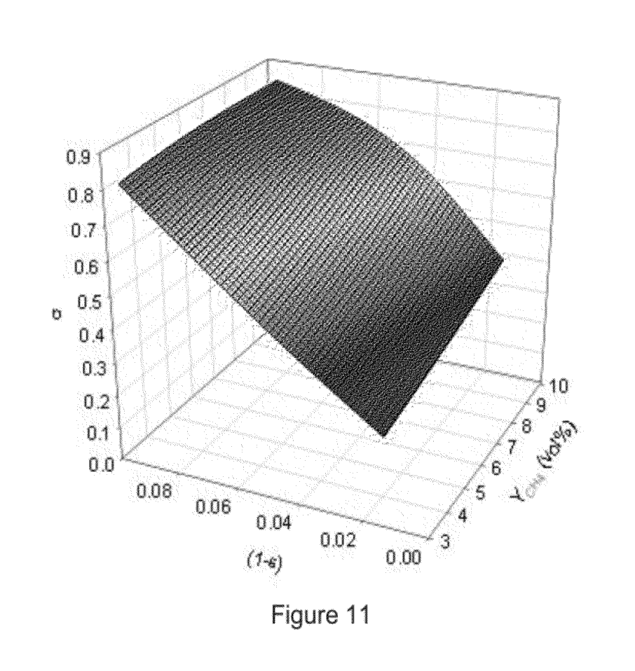

For each test run listed in Table 1, a variance σ of the measurements of the methane molar fraction Y_{CH4} was calculated. FIG. 11 is a graph showing a variance as a function of time-average methane molar fraction and solids volume fraction. In FIG. 11, the variance σ is a function of time-average methane molar fraction Y_{CH4} and solids volume fraction (1-ε). Increasing the solids volume fraction (1-ε) greatly increased the variance σ. This confirms that the accuracy of the spectroscopic device 200 using the fiber-optic probe 216 improves with increasing the intensity of the IR beam. This may be achieved by using fiber-optic bundles, optimizing the signal transmission at the distal tips 212, 213 of the fiber-optic probe 216 and at the FT-IR spectrometer/fiber-optics interface, from Harrick Fibremate™ in the exemplary device of FIG. 2. The effect of decreasing the S/N may also be minimized by improving the curve smoothing technique to evaluate the baseline absorbance.

Real-time measurements of the methane molar fraction Y_{CH4} were characterized by greater errors than the time-averaged values. For example, FIG. 9 shows instantaneous measurements of the methane molar fraction Y_{CH4} with relative errors of more than 10% while the error on the time-averaged measurement of the methane molar fraction Y_{CH4} was smaller than 1%, as may be observed in Table 1, considering Run #2. Also, the maximum relative error of the time-averaged measurements of the methane molar fraction Y_{CH4} was 5.8%, as in the case of as may be observed in Table 1, considering Run #9. Applied to a multiphase reactor, the present method can measure precisely the time-averaged chemical species composition inside the regions of relatively small solids volume fractions (1-ε). The method can also be more sensitive to measurements of smaller solids volume fraction (1-ε) and gaseous species carrier composition Yᵢ by increasing the length of the trajectory of the IR beam path. Since an average species composition between dense and dilute phases can be measured by using a sampling probe and analyzing the samples, the chemical composition in the dense phase can be calculated by subtracting the dilute phase composition from the average of dilute and dense phase compositions.

The method described in relation to Example 2 may be used to characterize a jet shape of a mixture, for analyzing chemical reaction properties of the mixture, and for analyzing reaction kinetics between carrier and fraction, offering simultaneous measurements of both phase characteristics and chemical composition of elements of the mixture, as they occur, for example at a tip of an injector.

### Example 3

The fiber-optic probe of FIG. 2 can also be used inside a fluidized bed of Fluid Catalytic Cracking (FCC) catalyst to measure a tracer molar fraction inside bubble and emulsion phases, with a solids volume fraction.

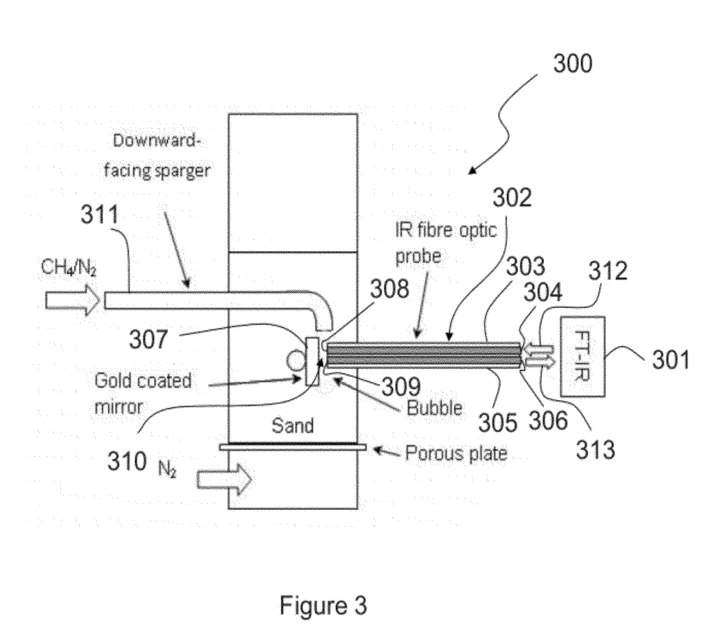

More specifically, FIG. 3 is a block diagram of a third embodiment of the spectroscopic device. A spectroscopic device 300 was used in Example 3 for a simultaneous and quantitative measurement of a non-limiting, exemplary gaseous species carrier composition Yᵢ and solids volume fraction (1-ε). The spectroscopic device 300 comprises:
a FT-IR spectrometer 301, for example Varian Excalibur™ series 3100, equipped with a FT-IR interferometer (not shown) and a high sensitivity mercury-cadmium-telluride (MCT) detector (not shown) cooled with liquid nitrogen;
a fiber-optic probe 302 comprising:
   an emitting fiber-optic 303 made of fluoride glass, having a numerical aperture of 0.2 and a core diameter of 600 μm, and having a proximal end 304 optically coupled to the FT-IR interferometer of the spectrometer 301 through an appropriate optical coupler (not shown), for example a Harrick Fibremate™; and
   a receiving fiber-optic 305 parallel to the emitting fiber-optic 303, made of fluoride glass, having a numerical aperture of 0.2 and a core diameter of 600 μm, and having a proximal end 306 optically coupled to the MCT detector of the spectrometer 301 through the above-mentioned optical coupler (not shown), for example a Harrick Fibremate™; and
a planar gold-coated mirror 307 positioned perpendicular to distal tips 308 and 309 of the emitting fiber-optic 303 and receiving fiber-optic 305, at a distance d=5 mm from these distal tips 308 and 309 to define a gas/solid flow measurement volume 310.

In an embodiment, the fiber-optic probe 302 may be a high temperature probe capable of supporting temperatures in the range of 1000° C., for use in industrial fluidized beds.

In operation, the FT-IR interferometer of the spectrometer 301 produced an IR beam 312 propagated through the emitting fiber-optic 303 and then through the measurement volume 310. The planar gold-coated mirror 307, positioned perpendicularly at a distance of five (5) mm from the distal tips 308 and 309 of the emitting fiber-optic 303 and receiving fiber-optic 305, reflected the IR beam from the distal tip 308 of the emitting fiber-optic 303 toward the distal tip 309 of the receiving fiber-optic 305 to define the measurement volume 310. The receiving fiber-optic 305 propagated the reflected IR beam 313 toward the MCT detector of the FT-IR spectrometer 301.

Still referring to FIG. 3, gas tracing was performed in a small scale fluidized bed reactor having an internal diameter of five (5) cm. The fiber-optic probe 302 was used to measure the tracer molar fraction (methane molar fraction Y_{CH4}) inside the bubble and emulsion phases in the measurement volume 310. The reactor was filled with FCC particles having an average particle size (dp) of 83 μm and 14% fines, and was incipiently fluidized with nitrogen (N₂) at a superficial gas velocity of 2.6 mm/s, with a minimum fluidization velocity (Umf) of 2.5 mm/s and a minimum bubbling velocity (Umb) of 2.7 mm/s. The expanded bed height was 12.5 cm and the fiber-optic probe 302 was inserted in the bed at a height of seven (7) cm. The planar gold-coated mirror 307 was positioned perpendicular at the distal tip of the fiber-optic probe 302, specifically at distal tips 308 and 309 of the emitting fiber-optic 303 and receiving fiber-optic 305, and gas bubbles were produced in the measurement volume 310 by injecting a mixture containing 10.1 vol % of methane (CH₄) and 89.9 vol % or nitrogen (N₂) through a downward facing sparger 311. The mixture containing 10.1 vol % of methane (CH₄) and 89.9 vol % or nitrogen (N₂) was injected at a flow rate of 10 mL/s by manually opening a toggle valve for roughly 0.5 second at an interval of approximately 11 seconds.

Results and Discussion

As described in the foregoing description, during transmission spectroscopy in a multiphase sample, both particles and carrier species contribute to the absorbance spectrum according to Equation (1), which may be simplified to Equation (2). As expressed hereinabove, in Equation (2), the effects of a volume fraction (1-ε) and carrier composition Yᵢ on the absorbance spectrum are independent. Therefore, the effect of a volume fraction (1-ε) and carrier composition Yᵢ can be calibrated independently.

Application to Fluidized Beds—Chemical Composition Measurement in the Bubble Phase

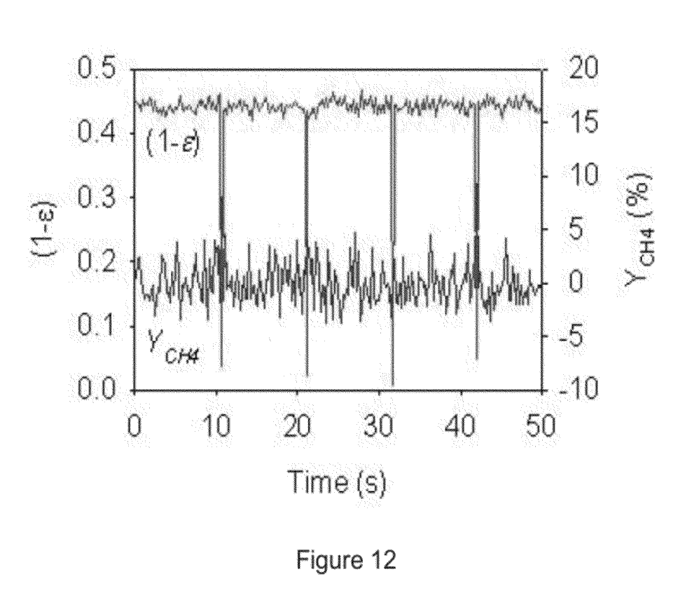

In the fluidized bed application of FIG. 3, the spectroscopic device 300 was used to measure the molar fraction of a methane (CH₄) tracer inside the bubble and emulsion phases. FIG. 12 is a graph showing a history of solids volume fraction and methane molar fraction measured by the spectrometer of FIG. 3. The history of solids volume fraction (1-ε) and methane molar fraction Y_{CH4} was measured by the FT-IR spectrometer 301 through the fiber-optic probe 302 during a typical measuring operation; the solids volume fraction (1-ε) was 0.45 in the emulsion phase and decreased significantly to 0.05-0 when gas bubbles of methane (CH₄) and nitrogen (N₂) were injected during roughly 0.5 second at intervals of approximately 11 seconds. The measured methane molar fraction Y_{CH4} in the emulsion phase fluctuated significantly (+5% to −5%) due to a low intensity of the transmitted IR beam and a resulting low S/N.

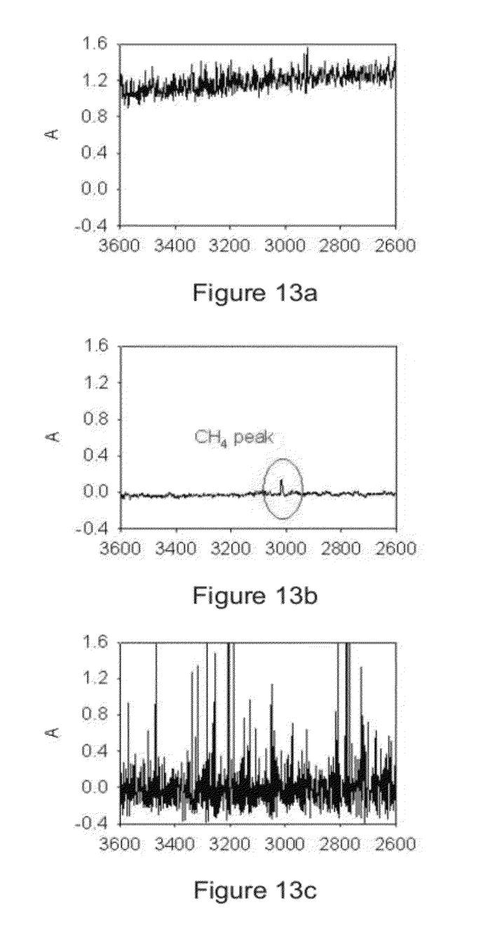

FIGS. 13a-13c are graphs showing (a) a typical absorbance spectrum measured in an emulsion phase, (b) an absorbance spectrum measured inside a bubble phase, and (c) a typical absorbance spectrum where noise was observed. The typical absorbance spectrum was measured in the emulsion phase. The low intensity of reflected signal resulted in a high absorbance throughout the spectrum. However, the time-average methane molar fraction Y_{CH4} was measured accurately as 0.0% (100% nitrogen N₂).

In FIG. 13b, the absorbance spectrum was measured inside the bubble phase. A methane peak was observed at 3017.63 cm⁻¹. However, the injection of bubbles produced gas/solids movement, which caused noise in most recorded absorbance spectra: 5 spectra out of the 27 measured in the bubble phase were sufficiently clear to make a measurement of the methane molar fraction Y_{CH4}.

In FIG. 13c, a typical absorbance spectrum is seen where noise was observed and the methane peak was indistinguishable. This noise may be eliminated in the wavelengths of interest by using a FT-IR spectrometer 301 operating at a higher modulation frequency.

The average peak height measured in the bubble phase corresponds to a methane molar fraction Y_{CH4} of 5% compared to the injected 10.1 vol % of methane (CH₄) in nitrogen (N₂). This discrepancy may be due to mixing in the measurement volume 310 between the gas injected through the downward facing sparger 311 and the fluidizing gas. Furthermore, the small number of clear spectra measured in the bubble phase may also explain the low value of methane molar fraction Y_{CH4} measured since time-average measurements are more accurate than instantaneous measurements. However, these results clearly show that the spectroscopic device 300 and method with a fiber-optic probe 302 can measure the gas composition in the bubble phase.

As mentioned hereinabove, both volume fraction and particle size influence the interaction between light and the particles, which in turn may affect a length of the trajectory of an IR beam and effective sample size. Gas/solid fluidized bed reactors are oftentimes used with an engineered solids phase having narrow particle size distribution. In the above results, no significant effect of the particle size on the absorbance spectra was observed.

Fluidized bed reactors are widely used in chemical, petrochemical, and food industries. Such beds are being developed for clean combustion technologies involving CO₂ sequestration, biorefinery, syngas production, production of chemicals from alternate feedstock, and the like. It can thus be appreciated from results shown on FIGS. 12 and 13a-13c that the method and spectroscopic device described herein may be applied in many industrial processes. The fiber-optic probe 302, due to its configuration, allows measuring volume fractions and chemical composition locally, at different regions inside fluidized beds.

The various experimental results described in relations to FIGS. 4a-4d to FIGS. 13a-13c represent test cases related to gas/solid systems subjected to the exemplary spectroscopic devices. However, those of ordinary skills in the art will appreciate that the method and devices are not limited to gas/solid systems but are also applicable to other types of multiphase systems.

One example of such a system may substitute the gaseous phase for a liquid phase. The system may thus comprise a colloidal fraction of solids blended in a liquid carrier. Some modifications to the various embodiments of the spectroscopic device described herein could be made, for example in order to maintain the liquid hermetically contained within a measurement volume such as the measurement volume 205 of FIG. 2; such modifications are of course within the capabilities of the skilled worker. Regardless, results similar to those depicted in FIGS. 4a-4d to FIGS. 13a-13c, with distinct numerical values, would be obtained by applying the same measurement and analysis method as described hereinabove. Of course, Equation (1) and its simplified form in Equation (2) apply equally to an exemplary liquid/solid compositions wherein the contribution A_{Yi, λ} from a gaseous species carrier composition Yᵢ is substituted with a contribution from a liquid species.

In another example, two distinct, immiscible liquids could form an emulsion, in which a first liquid forms a carrier in a continuous phase and a second liquid forms a smaller volume fraction in a dispersed phase. Equations (1) and (2) may be applied in the expanded version, of equation (3). The two contributions A_{Yi,λ} to represent the chemical compositions of the first liquid having the larger composition (subscript 1) and the second liquid having the smaller volume fraction (subscript 2). The two contributions A_{(1-ε), λ} (subscript 1 and 2) to represent the baseline absorbance signature of each liquid phase. The method allows the measurement of chemical composition in both immiscible liquids. Also, the method allows the determination of the phase in which the measurement is performed from either the measured chemical compositions (A_{(1-ε), λ}) or from the baseline absorbance signature (A_{(1-ε), λ}), which would be specific to each liquid phase.

A_{Total,λ}=└A_{Y}_{ᵢ}_{,λ}+A_{(1-ε),λ}┘₁+└A_{Y}_{ᵢ}_{,λ}+A_{(1-ε),λ}┘₂ (3)

In yet another example, a system may comprise a gas, liquid, gas/solid or liquid/solid first phase as a carrier, and a liquid, a gas, solid/gas or solid/liquid as a smaller fraction. The first phase may consist of a gas or a liquid forming a continuous phase. The first phase may alternatively comprise solids suspended in a gas or in a liquid, forming an emulsion phase, or dense phase. The second phase may consist of a gas or liquid with or without solids forming a bubble phase, or dilute phase Equations (1) and (2) may be applied in the expanded version, of equation (3). In equation (3), the contribution A_{Yi, λ} represents the chemical composition in each phase and A_{(1-ε),λ} represent the solid fraction in each phase. The two sections of equation (3) numerated by subscripts 1 and 2 refer to the contribution of the first and second phase, respectively.

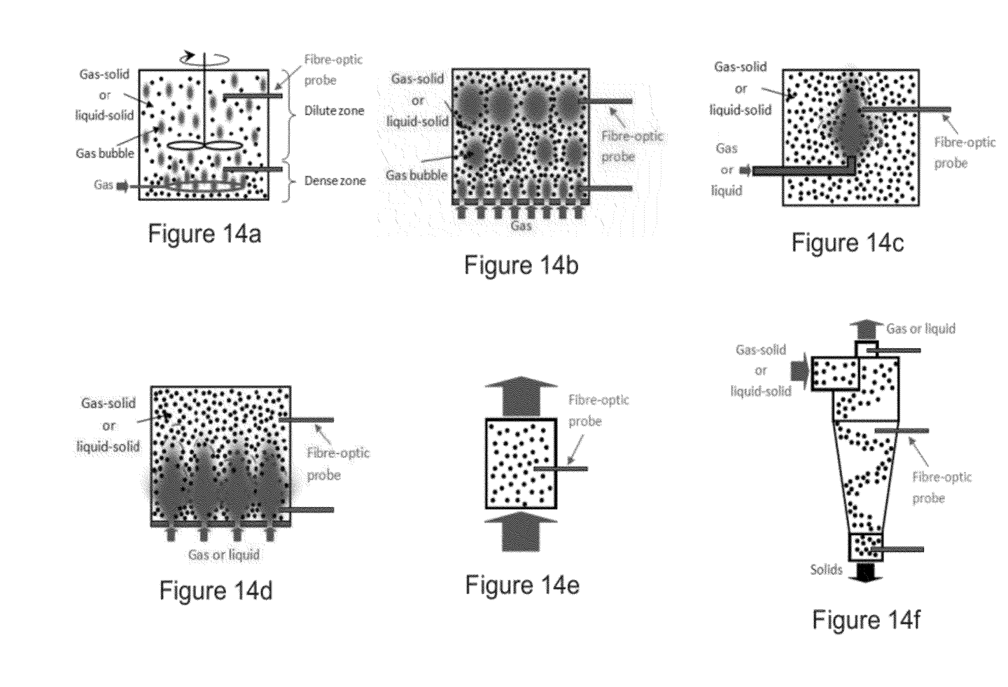

FIGS. 14a-14f are schematic views of various multiphase reactors. The various multiphase reactors provide examples of applications of the method and spectroscopic device, in which gas/solid, liquid/solid, liquid/liquid or gas/liquid/solid phases may be observed. All of FIGS. 14a-14f show various reactors comprising one or more fiber-optic probes connected to one or more spectroscopic device.

In FIG. 14a, a multiphase reactor comprises an agitated tank containing a liquid/solid or gas/solid mixture separated into a dilute (bubble) zone and a dense (emulsion) zone. An agitator is also shown. Two distinct fiber-optic probes are connected to a spectroscopic device or to two distinct spectroscopic devices, depending on alternative implementation choices of the device. The reactor allows on-line and simultaneous monitoring of solids suspension homogeneity and extent of a reaction between reactants, accounting for concentration of the various phases. Dead zones within the reactor may be identified. On-line measurement can be made in various phases, including gas bubbles and liquid phase, or dense zone and dilute zones. Monitoring is made of relations between solids fraction and chemical composition.

In FIG. 14b, a reactor may be a fluidized bed of a gas/solid mixture, a trickle bed of a gas/liquid/solid mixture, or a bubble column of a gas/liquid mixture. In the exemplary reactor of FIG. 14b, gas is injected from the bottom of the reactor. Two fiber-optic probes are shown. The reactor of FIG. 14b is applicable for example for biochemical processes such as fermentation. Microorganism growth, concentration of nutrients, or concentration of products and contaminants may be observed in the liquid and gas phases,

FIG. 14c shows gas or liquid injection in a multiphase reactor. The fiber-optic probe connected to the spectroscopic device disclosed herein may be used for on-line monitoring of a shape of a gas jet, monitoring of a liquid-liquid or gas-gas mixing around the jet, monitoring of gas-solid or liquid-solid mixing in various regions of the jet, along with effects of the mixing on a reaction, and on-line measurement of a quantity or gas or liquid injected in bubbles.

In FIG. 14d, selective oxidation or like fast reactions in a gas-solid fluidized bed may be observed. Based on a chemical composition of a gas-solid or liquid-solid mixture, one-line monitoring of a chemical composition around injectors and evaluation of gas-solid and gas-gas mixing intensity may be made.

FIG. 14e shows a multiphase stream reactor for use, for example, for pollution monitoring. Measurements of particles solids fraction and gaseous/liquid pollutant concentrations may be obtained. As a particular example, on-line measurement of soot volume fraction and gaseous pollutant concentration in a chimney of a coal boiler plant may be obtained via the fiber-optic probe.

FIG. 14f shows a cyclone separator in which on-line monitoring of a solids volume fraction and chemical/physical composition of a mixture may be obtained. This can be used for monitoring an efficiency of the cyclone separator and for detection of chemical reactions.

Although the present invention has been described in the foregoing description by way of illustrative embodiments thereof, these embodiments can be modified at will, within the scope of the appended claims without departing from the spirit and nature of the subject invention.

What is claimed is:

1. A method for performing two simultaneous measurements of a sample in a gas/solid, liquid/solid, liquid/liquid, liquid/gas or gas/liquid/solid multiphase system, comprising:
a first measurement of at least one of the following:
a phase in which the sample lies; and/or
a solids volume fraction of the sample; and
a second simultaneous quantitative measurement of a gaseous or liquid chemical composition of the sample.

2. A method as defined in claim 1, wherein the phase is selected from the group consisting of a dispersed phase, a continuous phase, a bubble phase comprising gas and/or liquid and/or solid, and an emulsion phase comprising a suspension of solids in a gas or liquid.

3. A method as defined in claim 1, comprising:
generating a light beam propagating through the multiphase system; and
detecting a spectrum of absorbance of the light beam propagating through the multiphase system in response to said light beam having propagated through the multiphase system, said spectrum of absorbance being representative of the first and second measurements.

4. A method as defined in claim 3, comprising propagating the generated light beam through an emitting fiber-optic with a distal tip, propagating the light beam from the distal tip of the emitting fiber-optic through the multiphase system, reflecting the light beam having propagated through the multiphase system on a mirror, propagating the reflected light beam through the multiphase system from the mirror toward a distal tip of a receiving fiber-optic, and propagating the reflected light beam having propagated through the multiphase system from the mirror to the distal tip of the receiving fiber-optic through the receiving fiber-optic for detection of the absorbance spectrum.

5. A method as defined in claim 3, wherein:
the spectrum of absorbance of the light beam is equal to:
A_{Total,λ}=A_{(1-ε),λ}+A_{Y}_{ᵢ}_{,λ}[fn(1-ε)];
wherein:
A_{Total, λ} is a total absorbance at a wavelength λ;
A_{(1-ε) λ} is a contribution from a volume fraction (1-ε),
A_{Yi,λ} is a contribution from a carrier composition, and
fn is a function of the solids volume fraction (1-ε) affecting light absorbed by the carrier composition.

6. A method as defined in claim 5, wherein fn(1-ε) is equal to 1.

7. A method as defined in claim 1, comprising:
averaging successive first measurements; and
averaging successive second measurements.

8. A device for performing two simultaneous measurements of a sample in a gas/solid, liquid/solid, liquid/liquid, gas/liquid or gas/liquid/solid multiphase system, comprising:
a generator of light beam for propagating through the sample of the multiphase system; and
a detector of a spectrum of absorbance of the light beam propagating through the sample in response to said light beam having propagated through the sample, said spectrum of absorbance being representative of the two simultaneous measurements.

9. A device as defined in claim 8, comprising a fiber-optic probe with a distal tip, and a mirror at a given distance from the fiber-optic probe and oriented to maximize transmission of the light beam to the detector.

10. A device as defined in claim 9, wherein the fiber-optic probe comprises an emitting fiber-optic and a receiving fiber-optic, wherein the emitting fiber-optic extends from the generator of light beam to the distal tip of the fiber-optic probe and the receiving fiber-optic extends from the distal tip of the fiber-optic probe to the detector of absorbance spectrum.

11. A device as defined in claim 9, wherein the mirror is a planar gold-coated mirror.
